(19) United States
(12) Patent Application Publication
(10) Pub. No.: US 2026/0200124 A1
(43) Pub. Date: Jul. 16, 2026

(54) Fastener Driving Machine

(71) Applicant: XIAO HUA DENG, SUZHOU (CN)

(72) Inventor: XIAO HUA DENG, SUZHOU (CN)

(21) Appl. No.: 19/023,050

(22) Filed: Jan. 15, 2025

(51) Int. Cl. B27F 7/11

(52) U.S. Cl. CPC B27F 7/11

(57) ABSTRACT

A fastener driving machine includes an impact unit, a push unit, a drive unit, and a reset unit. The impact unit has an initial position, a first transition position, a second transition position, and an energy storage position. The push unit has a first position corresponding to the first transition position and a second position corresponding to the second transition position. At the initial position, the impact unit is not engaged with the push unit; at the first transition position, the impact unit is engaged with the push unit; at the second transition position, the impact unit is disengaged from the push unit. The push unit is engaged with the impact unit and drives the impact unit from the first transition position to the second transition position. The reset unit provides a reset force to move the push unit from the second position to the first position.

### FIELD OF THE INVENTION

The present invention relates to the field of power tools, specifically to a fastener driving machine.

### BACKGROUND OF THE INVENTION

Typically, a fastener driving machine includes an energy storage unit, a drive unit and an impact unit. The impact unit drives a fastener into a workpiece in a first direction under the action of the energy released by the energy storage unit. The drive unit includes a plurality of first engaging teeth, while the impact unit includes a plurality of second engaging teeth. During an operation of the fastener driving machine, the plurality of first engaging teeth of the drive unit are sequentially engaged with the plurality of second engaging teeth of the impact unit, the drive unit drives the impact unit to move in a second direction, thereby storing energy in the energy storage unit, the second direction is opposite to the first direction. During an operation of the fastener driving machine, sometimes there may be situations where fasteners get stuck. When a jam occurs, the impact unit may not stop at a position where the impact unit can be correctly engaged with the drive unit, causing the fastener driving machine to fail to work properly.

Therefore, there is a need for an improved fastener driving machine.

### SUMMARY OF THE INVENTION

The present invention provides a fastener driving machine with stable and smooth operation.

One aspect of the present invention provides a fastener driving machine, the fastener driving machine includes an energy storage unit, an impact, a push unit, a drive unit and a reset unit. The energy storage unit is configured to store energy; the impact unit is configured to drive a fastener into a workpiece in a first direction under an action of the energy released by the energy storage unit; the push unit is configured to drive the impact unit to move; the drive unit is configured to provide power to the push unit and the impact unit. The impact unit has an initial position, a first transition position, a second transition position and an energy storage position arranged in a direction opposite to the first direction. The push unit has a first position corresponding to the first transition position and a second position corresponding to the second transition position. At the initial position, the impact unit is not engaged with the push unit; at the first transition position, the impact unit is engaged with the push unit; at the second transition position, the impact unit is disengaged from the push unit. When the impact unit is in the initial position, the drive unit is engaged with the impact unit and drives the impact unit to move; after the impact unit moves a predetermined distance, the drive unit is engaged with the push unit and drives the push unit to move; at the first position, the push unit is engaged with the impact unit and drives the impact unit from the first transition position to the second transition position. The reset unit provides a reset force to move the push unit from the second position to the first position.

Another aspect of the present invention provides a fastener driving machine, the fastener driving machine includes an energy storage unit, an impact unit, a push unit, a drive unit and a reset unit. The energy storage unit is configured to store energy; the impact unit is configured to drive a fastener into a workpiece in a first direction under an action of the energy released by the energy storage unit; the push unit is configured to drive the impact unit to move; the drive unit is configured to provide power to the push unit and the impact unit. The impact unit has an initial position, a first transition position, a second transition position and an energy storage position arranged in a direction opposite to the first direction. The push unit has a first position corresponding to the first transition position and a second position corresponding to the second transition position. At the initial position, the impact unit is not engaged with the push unit; at the first transition position, the impact unit is engaged with the push unit; at the second transition position, the impact unit is disengaged from the push unit. When the impact unit is in the initial position, the drive unit simultaneously drives the impact unit and the push unit to move; at the first position, the push unit is engaged with the impact unit and drives the impact unit from the first transition position to the second transition position. The reset unit is configured to provide a reset force to move the push unit from the second position to the first position.

Another aspect of the invention provides a fastener driving machine, the fastener driving machine includes an energy storage unit, an impact unit, a push unit, a drive unit and a reset unit. The energy storage unit is configured to store energy; the impact unit is configured to drive a fastener into a workpiece in a first direction under an action of the energy released by the energy storage unit, the impact unit has an initial position, a transition position and an energy storage position arranged in a direction opposite to the first direction; the push unit is configured to be engaged with the impact unit to drive the impact unit from the initial position to the transition position, the push unit has a first position corresponding to the initial position and a second position corresponding to the transition position; the drive unit is configured to be engaged with or disengaged from the push unit; the reset unit is configured to provide a reset force to move the push unit from the second position to the first position. When the impact unit is in the transition position, the push unit is in the second position, the push unit is disengaged from the impact unit under the reset force of the reset unit.

Another aspect of the invention provides a fastener driving machine, the fastener driving machine includes an energy storage unit, an impact unit, a push unit, a drive unit and a reset unit. The energy storage unit is configured to store energy; the impact unit is configured to drive a fastener into a workpiece in a first direction under an action of the energy released by the energy storage unit, the impact unit has an initial position, a first transition position, a second transition position and an energy storage position arranged in a direction opposite to the first direction; the push unit is configured to drive the impact unit to move, the push unit has a starting position, a first position corresponding to the first transition position and a second position corresponding to the second transition position; the drive unit is configured to provide power to the push unit and the impact unit. At the initial position, the impact unit is not engaged with the push unit; at the first transition position, the impact unit is engaged with the push unit; at the second transition position, the impact unit is disengaged from the push unit. The drive unit simultaneously drives the push unit and the impact unit to move, in a movement of the push unit from the starting position to the first position, the push unit catches up with the impact unit, when the push unit reaches the first position, the push unit is engaged with the impact unit and drives the impact unit from the first transition position to the second transition position. The reset unit provides a reset force to move the push unit from the second position to the first position.

Another aspect of the invention provides a fastener driving machine, the fastener driving machine includes an energy storage unit, an impact unit, a push unit, a drive unit and a reset unit. The energy storage unit is configured to store energy; the impact unit is configured to drive a fastener into a workpiece in a first direction under an action of the energy released by the energy storage unit, the impact unit has an initial position and an energy storage position; the push unit is configured to drive the impact unit from the initial position to the energy storage position, the push unit has a first position corresponding to the initial position and a second position corresponding to the energy storage position; the drive unit is configured to be engaged with or disengaged from the push unit; the reset unit is configured to provide a reset force to move the push unit from the second position to the first position.

The drive unit is engaged with the push unit, the push unit is engaged with the impact unit, the drive unit drives the impact unit through the push unit. The push unit can move from the second position to the first position under a reset force of the reset unit. When the impact unit stops at an abnormal position due to jamming, the drive unit can be always engaged with the push unit correctly, the drive unit drives the push unit to the abnormal position where the impact unit stops at, allowing the push unit and the impact unit to be reengaged correctly.

### BRIEF DESCRIPTION OF THE DRAWINGS

FIG. 1 is a structural schematic diagram of the fastener driving machine in the first embodiment of the present invention (partial structure omitted);

FIG. 2 is a structural schematic diagram of the fastener driving machine shown in FIG. 1 from one perspective;

FIG. 3 is a cross-sectional view along A-A of the fastener driving machine shown in FIG. 2;

FIG. 4 is a structural schematic diagram of the fastener driving machine shown in FIG. 1 from one perspective;

FIG. 5 is a cross-sectional view along B-B of the fastener driving machine shown in FIG. 4;

FIG. 6 is a structural schematic diagram of a partial structure of the fastener driving machine shown in FIG. 1;

FIG. 7 is a structural schematic diagram of the partial structure of the fastener driving machine shown in FIG. 6 from another perspective;

FIG. 8 is a structural schematic diagram of the partial structure of the fastener driving machine shown in FIG. 7 from another perspective;

FIG. 9 is a cross-sectional view along C-C of the partial structure of the fastener driving machine shown in FIG. 8;

FIG. 10 is a structural schematic diagram of the impact unit and the piston shown in FIG. 5;

FIG. 11 is a state diagram of each stage of an operating cycle of the fastener driving machine in the first embodiment of the present invention;

FIG. 12 is a state diagram of each stage of an operating cycle of the fastener driving machine in the first embodiment of the present invention under a condition that the fastener gets stuck;

FIG. 13 is a structural schematic diagram of a partial structure of the fastener driving machine in the second embodiment of the present invention;

FIG. 14 is a state diagram of each stage of an operating cycle of the fastener driving machine in the second embodiment of the present invention;

FIG. 15 is a state diagram of each stage of an operating cycle of the fastener driving machine in the second embodiment of the present invention under a condition that the fastener gets stuck;

FIG. 16 is a structural schematic diagram of a partial structure of the fastener driving machine in the third embodiment of the present invention;

FIG. 17 is a structural schematic diagram of the fastener driving machine shown in FIG. 16 from one perspective;

FIG. 18 is a cross-sectional view along A-A of the fastener driving machine shown in FIG. 17;

FIG. 19 is a structural schematic diagram of the fastener driving machine shown in FIG. 16 from one perspective;

FIG. 20 is a cross-sectional view along B-B of the fastener driving machine shown in FIG. 19;

FIG. 21 is a structural schematic diagram of a partial structure of the fastener driving machine shown in FIG. 16;

FIG. 22 is a structural schematic diagram of the impact unit and the piston shown in FIG. 20;

FIG. 23 is a structural schematic diagram of a partial structure of the fastener driving machine shown in FIG. 16 from one perspective;

FIG. 24 is a cross-sectional view along C-C of the partial structure of the fastener driving machine shown in FIG. 23;

FIG. 25 is a state diagram of each stage of an operating cycle of the fastener driving machine in the third embodiment of the present invention;

FIG. 26 is a state diagram of each stage of an operating cycle of the fastener driving machine in the third embodiment of the present invention under a condition that the fastener gets stuck;

FIG. 27 is a structural schematic diagram of a partial structure of the fastener driving machine in the fourth embodiment of the present invention;

FIG. 28 is a state diagram of each stage of an operating cycle of the fastener driving machine in the fourth embodiment of the present invention;

FIG. 29 is a state diagram of each stage of an operating cycle of the fastener driving machine in the fourth embodiment of the present invention under a condition that the fastener gets stuck.

### DETAILED DESCRIPTION OF THE EMBODIMENTS

The exemplary embodiments will be described in detail herein, with examples illustrated in the drawings. In the descriptions related to the drawings, unless otherwise indicated, identical numbers across different drawings denote identical or similar elements. The embodiments described in the following exemplary embodiments do not represent all possible embodiments consistent with the present invention.

The terminology used in the present invention is solely for the purpose of describing specific embodiments and is not intended to limit the invention. Unless otherwise defined, technical and scientific terms used in the present invention should have the meanings commonly understood by those skilled in the field to which the invention belongs. Terms like “first,” “second,” and similar do not imply any order, quantity, or importance but are used solely to distinguish between different components. Similarly, terms like “a” or “an” do not imply a limitation on quantity but indicate the presence of at least one. “Multiple” or “several” indicates two or more. Unless otherwise indicated, terms like “front,” “rear,” “lower,” and/or “upper” are used for convenience in description and do not limit position or spatial orientation. Terms like “including” or “comprising” mean that the elements or objects before these terms encompass elements or objects listed after them, along with their equivalents, and do not exclude other elements or objects. Terms like “connected” or “linked” are not limited to physical or mechanical connections and may include electrical connections, whether direct or indirect. In the specification and appended claims, singular forms such as “a,” “the,” and “this” are also intended to include plural forms unless the context clearly indicates otherwise. It should also be understood that terms such as “and/or” indicate any or all possible combinations of one or more of the associated listed items.

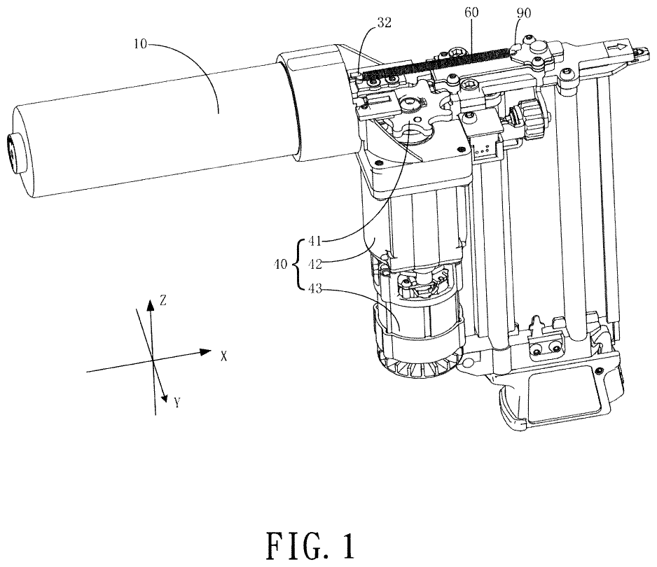

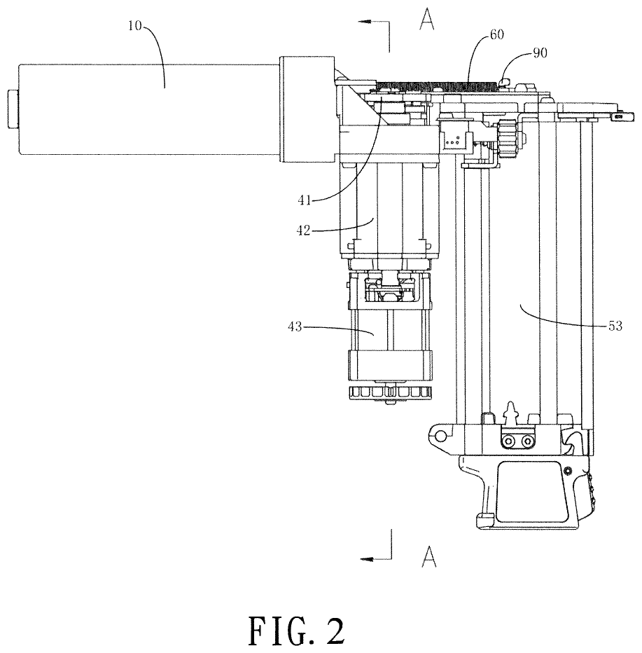

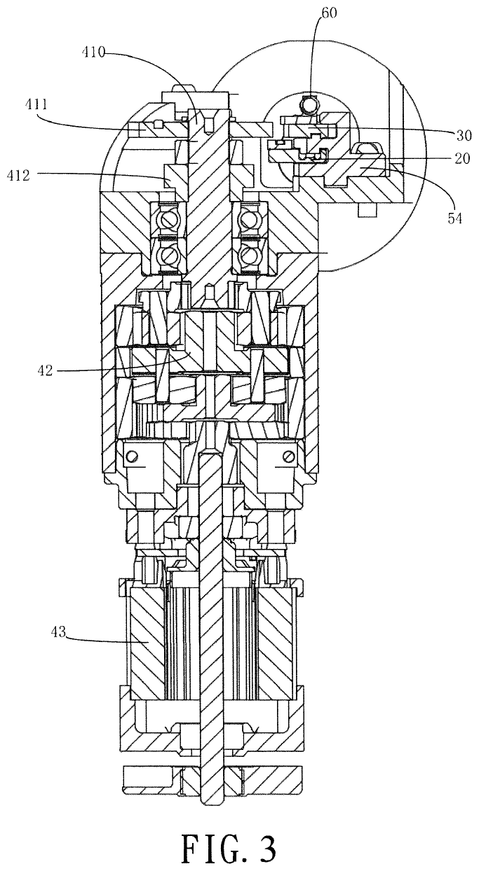

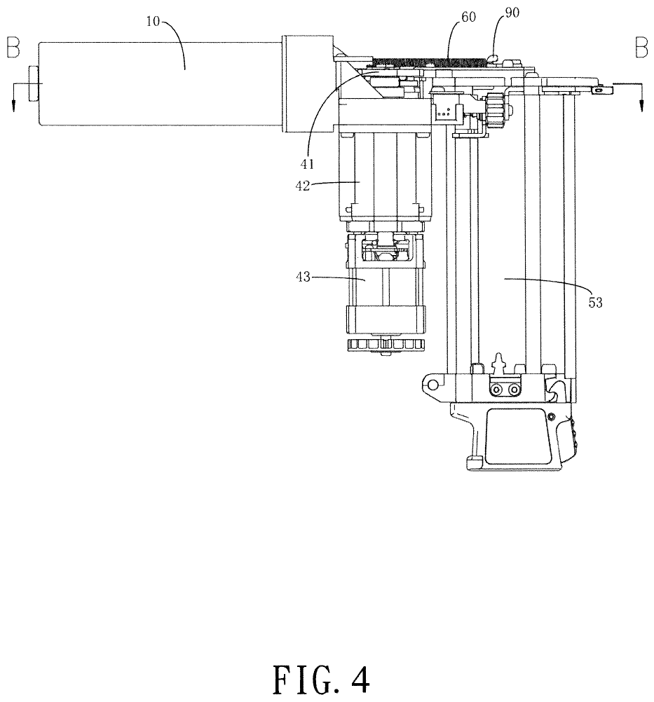

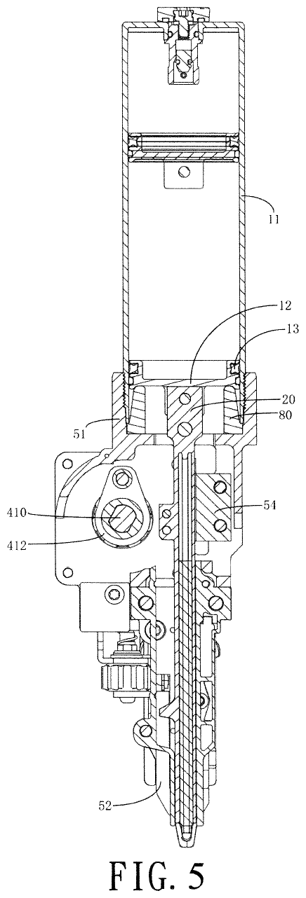

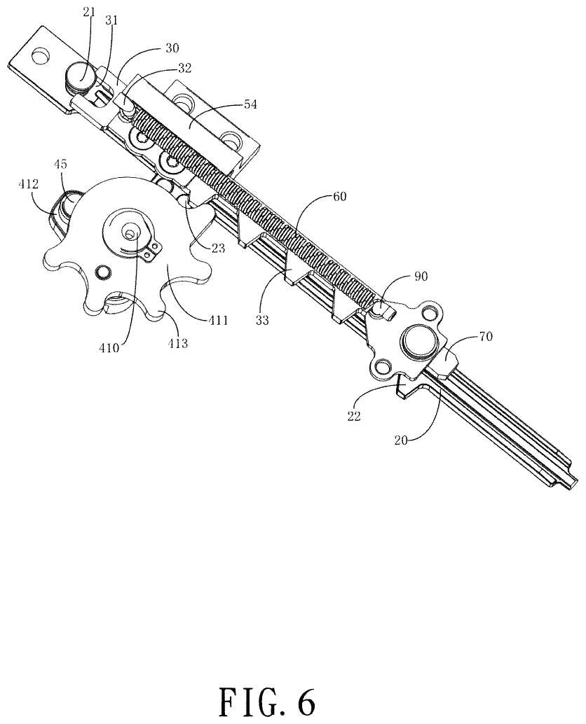

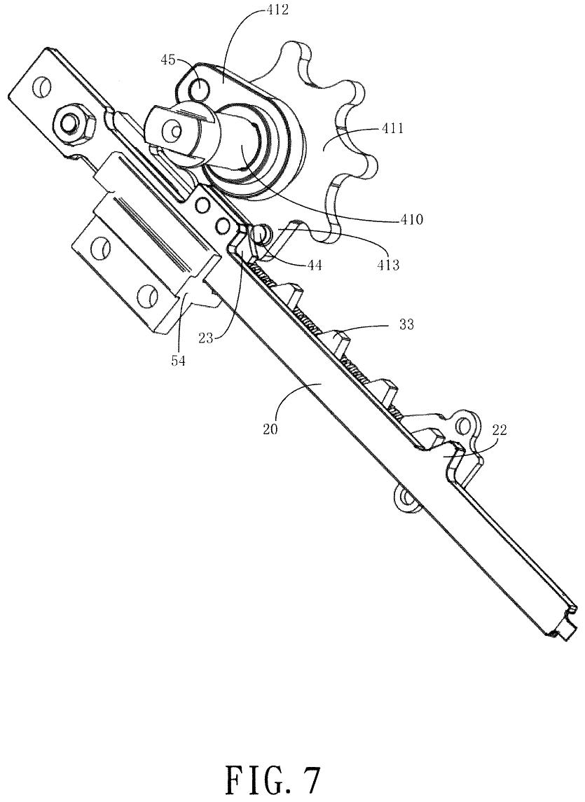

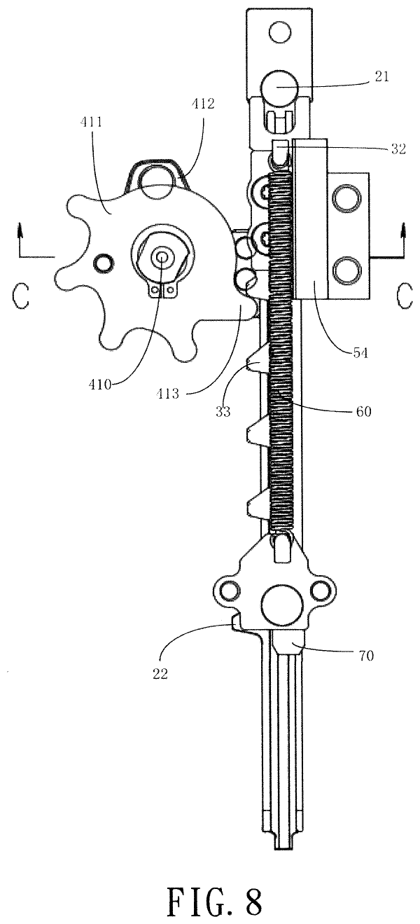

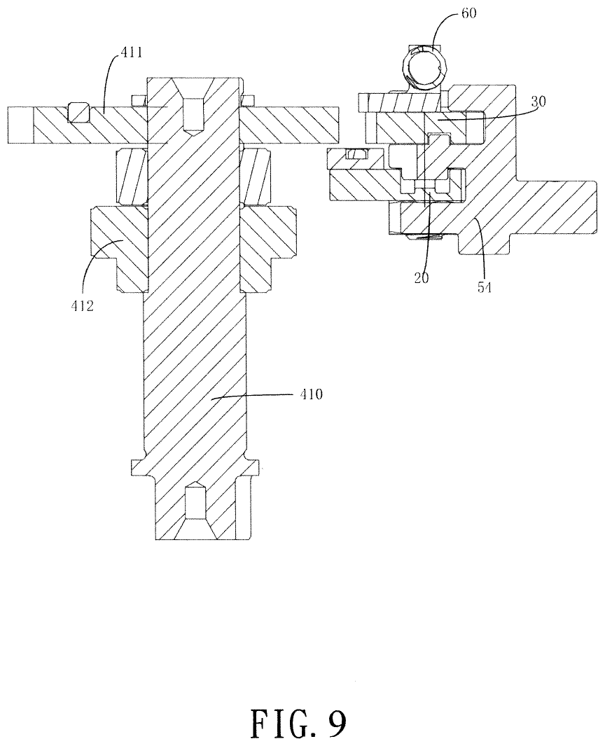

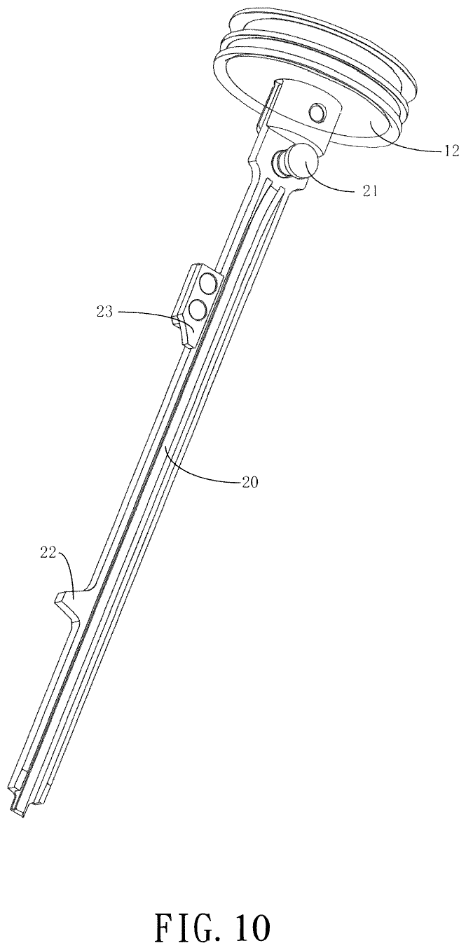

Referring to FIGS. 1 to 12, the first embodiment of the present invention provides a fastener driving machine that includes an energy storage unit 10, an impact unit 20, a push unit 30, a drive unit 40, a support unit, and a reset unit 60. The support unit is configured to support the energy storage unit 10, the impact unit 20, the push unit 30 and the drive unit 40. The drive unit 40 is configured to provide power to the push unit 30 and the impact unit 20. The reset unit 60 has a first end and a second end opposite to each other, the first end of reset unit 60 is connected with the support unit, and the second end of reset unit 60 is connected with the push unit 30. The support unit includes a base 51. The fastener driving machine further includes a fastener guide plate 52 and a fastener storage clip 53. The fastener storage clip 53 is connected to the fastener guide plate 52 and contains fasteners (not shown in the figure). The fastener storage clip 53 can transport fasteners to the fastener guide plate 52, which guides the fasteners. The fasteners are driven into the workpiece by the impact unit 20. In this invention, the fastener is a nail, the fastener guide plate 52 is a nail guide plate, and the fastener storage clip 53 is a nail storage clip.

The energy storage unit 10 is a medium that can store energy through displacement, such as air spring, mechanical spring, or rubber element. In this invention, the energy storage unit 10 is an air spring and includes a cylinder 11, a piston 12, and a sealing ring 13. The cylinder 11 and the piston 12 form an enclosed space containing gas, sealed by the sealing ring 13 between the cylinder 11 and the piston 12. One end of the impact unit 20 is connected with the piston 12, and the other end of the impact unit 20 is used to drive the fastener into the workpiece. The impact unit 20 can move together with the piston 12. The energy storage unit 10 is used to store energy. When the energy storage unit 10 releases the energy, the impact unit 20 drives the fastener into the workpiece along the first direction X under the action of the energy released by the energy storage unit 10.

The impact unit 20 has an initial position, a first transition position, a second transition position, and an energy storage position arranged in a direction opposite to the first direction X. The first transition position and the second transition position are located between the initial position and the energy storage position. The piston 12 has a top dead center corresponding to the energy storage position and a bottom dead center corresponding to the initial position. When the impact unit 20 is in the energy storage position, the piston 12 is at the top dead center, and the energy storage unit 10 is in an energy storage state. When the impact unit 20 is in the initial position, the piston 12 is at the bottom dead center, and the energy storage unit 10 is in an energy released state. The push unit 30 has a starting position, a first position corresponding to the first transition position, and a second position corresponding to the second transition position. “The push unit 30 has a first position corresponding to the first transition position” means that when the impact unit 20 is located at the first transition position, the push unit 30 is located at the first position. “The push unit 30 has a second position corresponding to the second transition position” means that when the impact 20 is located at the second transition position, the push unit 30 is located at the second position.

At the initial position, the impact unit 20 is not engaged with the push unit 30; at the first transition position, the impact unit 20 is engaged with the push unit 30; at the second transition position, the impact unit 20 is disengaged from the push unit 30. The drive unit 40 is engaged with the impact unit 20 and drives the impact unit 20 from the initial position to the first transition position. After the impact unit 20 moves a predetermined distance, the drive unit 40 is engaged with the push unit 30 and drives the push unit 30 from the starting position to the first position. Since a moving speed of the impact unit 20 is less than that of the push unit 30, the push unit 30 catches up with the impact unit 20 and is engaged with the impact unit 20 at the first position, at this moment, the impact unit 20 is located at the first transition position, the push unit 30 is located at the first position. The push unit 30 is engaged with the impact unit at the first position and drives the impact unit 20 from the first transition position to the second transition position. Once the impact unit 20 reaches the second transition position, the drive unit 40 is engaged with the impact unit 20 and drives the impact unit 20 from the second transition position to the energy storage position.

The drive unit 40 is configured to be engaged with or disengaged from the push unit 30. Before the push unit 30 is engaged with the impact unit 20, the drive unit 40 is engaged with the impact unit 20 and drives the impact unit 20 from the initial position to the first transition position. During a process of the drive unit 40 driving the impact unit 20 from the initial position to the first transition position, the drive unit 40 is engaged with the push unit 30. When the drive unit 40 is engaged with the push unit 30, the drive unit 40 drives the push unit 30 from the starting position to the first position. The push unit 30 is engaged with the impact unit 20 at the first position and drives the impact unit 20 from the first transition position to the second transition position, the impact unit 20 drives the piston 12 to move. When the push unit 30 is engaged with the impact unit 20, the drive unit 40 is about to be disengaged from the impact unit 20. During a process of the push unit 30 driving the impact unit 20 to move, the drive unit 40 is reengaged with the impact unit 20, the drive unit 40 is about to be disengaged from the push unit 30. When the drive unit 40 is disengaged from the push unit 30, the impact unit 20 is located at the second transition position, and the push unit 30 is located at the second position. At this moment, the push unit 30 moves from the second position to the first position under the reset force of the reset unit 60 until the push unit 30 returns to the starting position. The impact unit 20 is disengaged from the push unit 30 at the second transition position, the drive unit 40 is engaged with the impact unit 20 and drives the impact unit 20 from the second transition position to the energy storage position. When the impact unit 20 is located at the energy storage position, the piston 12 is at the top dead center, and the energy storage unit 10 is in an energy storage state. The reset unit 60 provides a reset force to move the push unit 30 from the second position to the first position. The push unit 30 moves from the second position to the first position until the push unit 30 returns to the starting position under the reset force of the reset unit 60. When the impact unit 20 is located at the second transition position, the push unit 30 is located at the second position, the push unit 30 is disengaged from the impact unit 20 at the second position under the reset force of the reset unit 60. The reset unit 60 extends along a moving direction of the impact unit 20. In this invention, the reset unit 60 is a tension spring with a first end and a second end. The first end of reset unit 60 is connected with the support unit, and the second end of reset unit 60 is connected with the push unit 30. The support unit includes a first hook 90, the first end of the reset unit 60 is mounted on the first hook 90 which is fixed to the fastener guide plate 52. The push unit 30 includes a second hook 32, the second end of the reset unit 60 is mounted on the second hook 32 of the push unit 30. When the push unit 30 is in the second position, the reset unit 60 is in a stretched state.

The push unit 30 includes a groove 31, the groove 31 is open in a direction opposite to the first direction X. The impact unit 20 includes a protrusion 21 configured to fit into the groove 31. During a movement of the push unit 30 from the starting position to the first position, the protrusion 21 fits into the groove 31. During a movement of the push unit 30 from the first position to the second position, the protrusion 21 is positioned in the groove 31, and the impact unit 20 is pushed by the push unit 30 in the direction opposite to the first direction X. When the impact unit 20 is located at the second transition position, the push unit 30 is located at the second position, the groove 31 is disengaged from the protrusion 21 under the reset force of the reset unit 60. In this invention, the push unit 30 is a rack rod, and the protrusion 21 is a pin mounted on the body of the impact unit 20.

The drive unit 40 includes a motor 43, an output shaft 410, a decelerating mechanism 42, and a drive mechanism 41. The motor 43 provides power to the drive mechanism 41. The drive mechanism 41 includes a drive wheel 411, a first engaging structure 44, and a second engaging structure 45, the drive wheel 411 is mounted on the output shaft 410. The impact unit 20 includes a first protrusion 23 and a second protrusion 22. The first engaging structure 44 is engaged with the first protrusion 23 to drive the impact unit 20 from the initial position to the first transition position, the second engaging structure 45 is engaged with the second protrusion 22 to drive the impact unit 20 from the second transition position to the energy storage position. The drive wheel 411 has a meshing area and a non-meshing area arranged circumferentially, the meshing area is meshed with at least one tooth of the push unit 30 to form a meshing state. Specifically, the meshing area includes a plurality of first engaging teeth 413, the push unit 30 includes a plurality of second engaging teeth 33, the plurality of first engaging teeth 413 are sequentially meshed with the plurality of the second engaging teeth 33 to form a meshing state. The first engaging structure 44 is disposed at the first one of the plurality of first engaging teeth 413 of the meshing area of the drive wheel 411, the meshing area of the drive wheel 411 begins to be meshed with the second engaging teeth 33 of the push unit 30 through the first one of the plurality of first engaging teeth 413. The first engaging structure 44 and the first engaging tooth 413 are arranged along the axial direction of the output shaft 410. The second engaging structure 45 and the drive wheel 411 are positioned on two different planes along the axis direction of the output shaft 410. The drive mechanism 41 includes a crank 412, the crank 412 is mounted on the output shaft 410. The crank 412 includes a pin shaft and a sleeve mounted on the pin shaft, the pin shaft and the sleeve function as the second engaging structure 45, the second engaging structure 45 is engaged with the second protrusion 22 of the impact unit 20. The purpose of the sleeve is to reduce friction; the sleeve is not essential for the engaging function. The second engaging structure 45 can be engaged with or disengaged from the second protrusion 22. When the second protrusion 22 is disengaged from the second engaging structure 45, the impact unit 20 drives the fastener into the workpiece under the action of the energy released by the energy storage unit 10.

During the process of the drive unit 40 driving the impact unit 20 from the initial position to the first transition position, the first engaging tooth 413 in the meshing area of the drive wheel 411 of the drive mechanism 41 of the drive unit 40 begins to be meshed with the second engaging tooth 33 of the push unit 30. When the drive unit 40 is engaged with the push unit 30, the drive unit 40 drives the push unit 30 from the starting position to the first position. The push unit 30 is engaged with the impact unit 20 at the first position and drives the impact unit 20 from the first transition position to the second transition position, the first engaging structure 44 is about to be disengaged from the first protrusion 23. After the first engaging tooth 413 in the meshing area of the drive wheel 411 is disengaged from the second engaging tooth 33 of the push unit 30, the second engaging structure 45 is engaged with the second protrusion 22. The second engaging structure 45 is engaged with the second protrusion 22 to drive the impact unit 20 from the second transition position to the energy storage position.

Specifically, under an action of the motor 43, the output shaft 410 begins to rotate, the drive wheel 411 and the crank 412 rotate with the output shaft 410. The first engaging structure 44 disposed at the first engaging tooth 413 is engaged with the first protrusion 23 to drive the impact unit 20 from the initial position to the first transition position. During a movement of the impact unit 20 from the initial position to the first transition position, the first engaging tooth 413 in the meshing area of the drive wheel 411 begins to be engaged with the second engaging tooth 33 of the push unit 30. When the first engaging tooth 413 of the meshing area of the drive wheel 411 is engaged with the second engaging tooth 33 of the push unit 30, the drive wheel 411 drives the push unit 30 from the starting position to the first position. The push unit 30 is engaged with the impact unit 20 at the first position, the push unit 30 drives the impact unit 20 from the first transition position to the second transition position, the first engaging structure 44 is about to be disengaged from the first protrusion 23. During a process of the push unit 30 driving the impact unit 20 from the first transition position to the second transition position, the second engaging structure 45 is engaged with the second protrusion 22 to drive the impact unit 20 from the second transition position to the energy storage position. During a process of the drive mechanism 41 driving the impact unit 20 from the second transition position to the energy storage position, the first engaging tooth 413 of the meshing area of the drive wheel 411 begins to be disengaged from the second engaging tooth 33 of the push unit 30. When the first engaging tooth 413 of the meshing area of the drive wheel 411 is disengaged from the second engaging tooth 33 of the push unit 30, the push unit 30 is located at the second position, and the impact unit 20 is located at the second transition position. At this moment, the push unit 30 moves from the second position to the first position under the reset force of the reset unit 60 until the push unit 30 returns to the starting position. The second engaging structure 45 is engaged with the second protrusion 22, the drive unit 40 drives the impact unit 20 from the second transition position to the energy storage position until the impact unit 20 is located at the energy storage position. When the second engaging structure 45 is disengaged from the second protrusion 22, the impact unit 20 drives the fastener into the workpiece along the first direction X under the action of energy released by the energy storage unit 10.

The push unit 30 and the drive wheel 411 are opposite to each other along the second direction Y. The push unit 30 includes a tooth-meshing region configured to be meshed with the drive wheel 411; and along the second direction Y, the reset unit 60 is positioned on a side of the tooth-meshing region of the push unit 30 facing away from the drive wheel 411. The second direction Y is perpendicular to the first direction X. The reset unit 60 and the impact unit 20 are arranged along the third direction Z, the third direction Z is perpendicular to the first direction X and the second direction Y.

Specifically, the decelerating mechanism 42 is a gear transmission mechanism, which is used to reduce speed and increase torque. The gear transmission mechanism includes one or more stages of planetary gear transmission, and in this invention, the gear transmission mechanism includes a three-stage planetary gear transmission. The gear transmission mechanism also includes a one-way clutch, so that when the drive mechanism 41 is engaged with the push unit 30 or the impact unit 20 and the motor 43 is not supplying torque, the energy released by the energy storage unit 10 cannot reverse the drive mechanism 41. The speed and torque output by the motor 43 are transmitted to the output shaft 410 through the gear transmission mechanism, the drive wheel 411 and the crank 412 can rotate together with the output shaft 410. A circlip is fitted to the output shaft 410 to prevent the drive wheel 411 and the crank 412 from detaching from the output shaft 410.

The support unit also includes a guide rail 54, the guide rail 54 is mounted on the base 51, the guide rail 54 defines two grooves. The impact unit 20 and the push unit 30 are correspondingly installed in these two grooves. The two grooves can respectively guide the impact unit and the push 30 unit, causing them to move in a straight line. The fastener driving machine also includes a first buffer 70 mounted on the fastener guide plate 52. When the push unit 30 returns to the starting position under the reset force of the reset unit 60, the push unit 30 abuts against the first buffer 70. The first buffer 70 is used to absorb the residual energy when the push unit 30 is abutting against the first buffer 70. Additionally, the first buffer 70 restricts a movement of the push unit 30 along the first direction X. The fastener driving machine further includes a second buffer 80 positioned between the base 51 and the piston 12. During a process of the impact unit 20 driving the energy storage unit 10 to store energy, the impact unit 20 drives the piston 12 to move away from the second buffer 80. During a process of the impact unit 20 driving the fastener into the workpiece under the action of the energy released by the energy storage unit 10, the piston 12 drives the impact unit 20 to the second buffer 80 until the piston 12 strikes the second buffer 80. When the impact unit 20 completes an action of fastener driving, the residual energy of the piston 12 is absorbed or dissipated by the second buffer 80, which prevents the impact unit 20 from damaging. Additionally, the second buffer 80 also restricts a movement of the impact unit 20 along the first direction X.

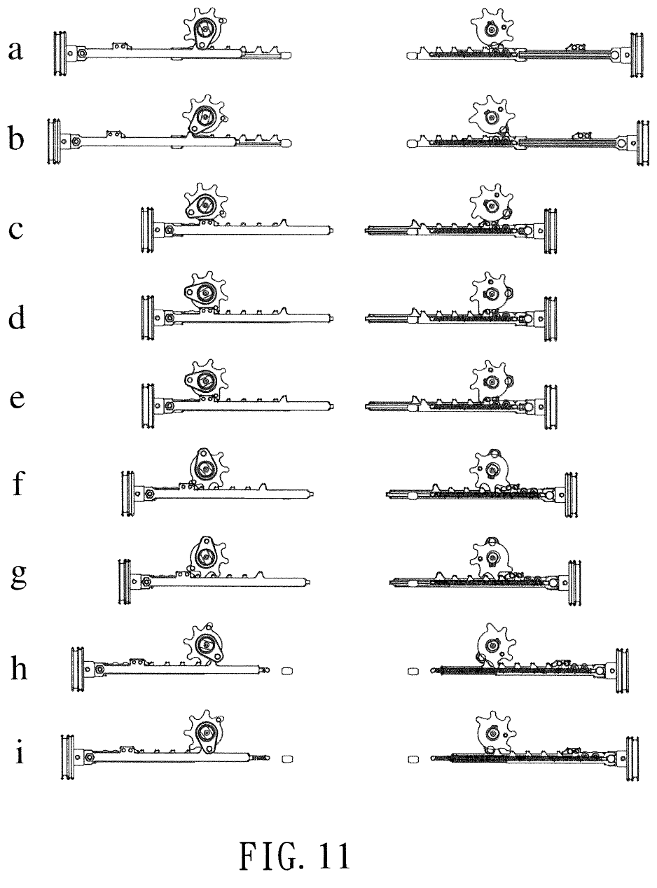

Referring to states a to i in FIG. 11, these states correspond to one complete operating cycle:

State a represents the initial state of the entire operating cycle, at this time, the impact unit 20 is in a pre-load position, the piston 12 is near to the top dead center, and the piston 12 has not reached the top dead center. The second protrusion 22 of the impact unit 20 is engaged with the second engaging structure 45 (the pin shaft and the sleeve), the push unit 30 returns to the starting position, and the push unit 30 abuts against the first buffer 70. The output shaft 410 rotates counterclockwise, as shown in state b, the output shaft 410 drives the drive wheel 411 and the crank 412 to rotate, and the second engaging structure 45 is engaged with the second protrusion 22 to drive the impact unit 20 to move in the direction opposite to the first direction X, the impact unit 20 drives the piston 12 to move in the direction opposite to the first direction X until the piston 12 reaches the top dead center. The output shaft 410 continues to rotate counterclockwise, and as shown in state c, the second protrusion 22 of the impact unit 20 is disengaged from the second engaging structure 45. The impact unit 20 drives the fastener into the workpiece along the first direction X under the action of the energy released by the energy storage unit 10. After the action of fastener driving is completed, the piston 12 abuts against the second buffer 80, the piston 12 stays at the bottom dead center, while the impact unit 20 is located at the initial position. The output shaft 410 drives the drive wheel 411 and the crank 412 to continue to rotate counterclockwise, as shown in state d, the first engaging structure 44 is engaged with the first protrusion 23 to drive the impact unit 20 to move in the direction opposite to the first direction X, the first engaging structure 44 is engaged with the first protrusion 23 to drive the impact unit 20 from the initial position to the first transition position. The first engaging tooth 413 of the meshing area of the drive wheel 411 is about to be engaged with the second engaging tooth 33 of the push unit 30.

The output shaft 410 continues to rotate counterclockwise, shown in state e, the first engaging tooth 413 of the meshing area of the drive wheel 411 begins to be engaged with the second engaging tooth 33 of the push unit 30 to drive the push unit 30 to move in the direction opposite to the first direction X. The output shaft 410 continues to rotate counterclockwise, the drive wheel drives the push unit 30 from the starting position to the first position. Since the moving speed of the impact unit 20 is slower than that of the push unit 30, the push unit 30 catches up with the impact unit 20 in the direction opposite to the first direction X, and the groove 31 in the push unit 30 is engaged with the protrusion 21 of the impact unit 20 at the first position. At this time, the impact unit 20 is in the first transition position, and the push unit 30 is in the first position, as shown in state f, the first engaging structure 44 is about to be disengaged from the first protrusion 23. The output shaft 410 continues to rotate counterclockwise, shown in state g, the output shaft 410 drives the drive wheel 411 and the crank 412 to rotate, the drive wheel 411 drives the push unit 30 to move, the push unit 30 drives the impact unit 20 from the first transition position to the second transition position, the impact unit 20 drives the piston 12 to move in the direction opposite to the first direction X to compress the air spring, and the first engaging structure 44 has been disengaged from the first protrusion 23. The output shaft 410 continues to rotates counterclockwise, shown in state h, the second engaging structure 45 (the pin shaft and the sleeve) begins to be engaged with the second protrusion 22 of the impact unit 20, and the first engaging tooth 413 of the drive wheel 411 is about to be disengaged from the second engaging tooth 33 of the push unit 30. The output shaft 410 continues to rotate counterclockwise, shown in state i, the first engaging tooth 413 of the drive wheel 411 is disengaged from the second engaging tooth 33 of the push unit 30, at this time, the push unit 30 is located at the second position. The push unit 30 will move from the second position to the first position under the reset force of the reset unit 60 until the push unit 30 returns to the starting position and abuts against the first buffer 70. When the push unit 30 is located at the second position, the impact unit 20 is located at the second transition position, and the second engaging structure 45 is engaged with the second protrusion 22 to drive the impact unit 20 from the second transition position to the energy storage position, the impact unit 20 drives the piston 12 to move to compress the air spring. The output shaft 410 continues to rotates counterclockwise, the second engaging structure 45 is engaged with the second protrusion 22 to drive the impact unit 20 to the pre-load position, completing one operating cycle, as shown in state a.

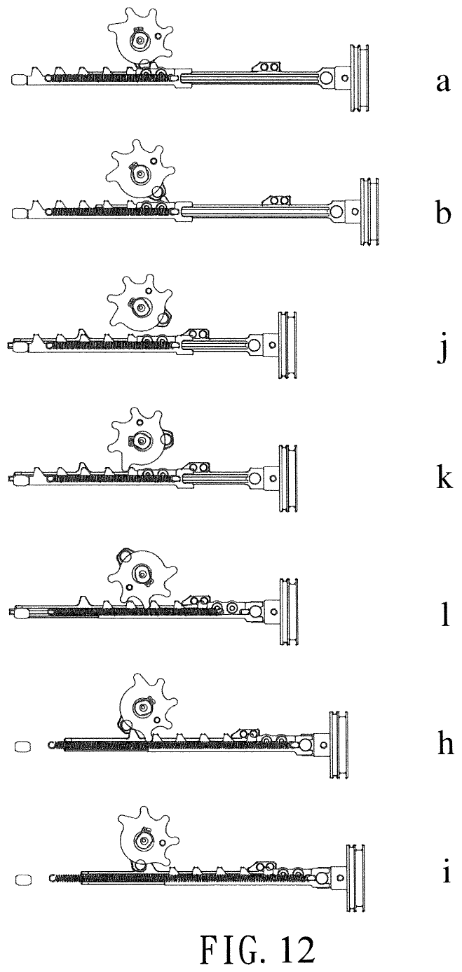

Referring to FIG. 12, for some reason, the fastener may get stuck in the fastener guide plate 52, and the impact unit 20 may stop at any position along the first direction X, as shown in state j. Since the push unit 30 and the impact unit 20 are not fixedly connected, the push unit 30 can return to the starting position and abut against the first buffer 70 under the reset force of the reset unit 60, the first engaging tooth 413 of the drive wheel 411 can be engaged with the second engaging tooth 33 of the push unit 30. The output shaft 410 continues to rotate counterclockwise, as shown in state k, the first engaging structure 44 can not be engaged with the first protrusion 23, and the first engaging tooth 413 of the drive wheel 411 is about to be engaged with the second engaging tooth 33 of the push unit 30, the drive wheel 411 drives the push unit 30 to move in the direction opposite to the first direction X. The output shaft 410 continues to rotate counterclockwise, shown in state l, the first engaging tooth 413 of the drive wheel 411 is engaged with the second engaging tooth 33 of the push unit 30, the drive wheel 411 drives the push unit 30 to move in the direction opposite to the first direction X until the push unit 30 is reengaged with the impact unit 20, the push unit 30 drives the impact unit 20 to move, the impact unit 20 drives the piston 12 to move in the direction opposite to the first direction X to compress the air spring. The output shaft 410 continues to rotate counterclockwise, shown in state h, the second engaging structure 45 (the pin shaft and the sleeve) begin to be engaged with the second protrusion 22 of the impact unit 20, and the first engaging tooth 413 of the drive wheel 411 is about to be disengaged from the second engaging tooth 33 of the push unit 30. The output shaft 410 continues to rotate counterclockwise, shown in state i, the first engaging tooth 413 of the drive wheel 411 is disengaged from the second engaging tooth 33 of the push unit 30, at this time, the push unit 30 is located at the second position. The push unit 30 is about to move from the second position to the first position under the reset force of the reset unit 60 until the push unit 30 returns to the starting position and abuts against the first buffer 70. The impact unit 20 is located at the second transition position, and the second engaging structure 45 is engaged with the second protrusion 22 to drive the impact unit 20 from the second transition position to the energy storage position, the impact unit 20 drives the piston 12 to move in the direction opposite to the first direction X to compress the air spring. The output shaft 410 continues to rotate counterclockwise, the second engaging structure 45 is engaged with the second protrusion 22 to drive the impact unit 20 to the pre-load position, completing one operating cycle, as shown in state a.

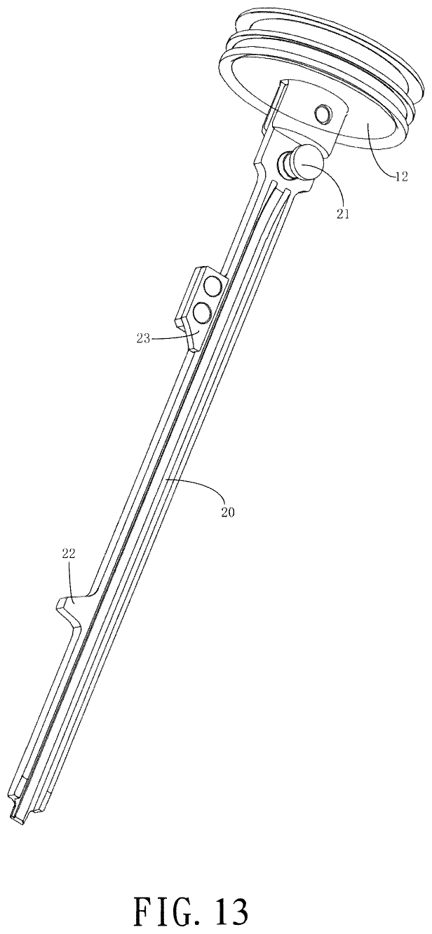

Referring to FIGS. 13 to 15, the second embodiment of the present invention also provides a fastener driving machine, FIG. 13 only provides a structural schematic diagram of a structure different from the structure of the first embodiment, please refer to FIGS. 1 to 10 for the same structure as the first embodiment, the fastener driving machine includes an energy storage unit 10, an impact unit 20, a push unit 30, a drive unit 40, a support unit and a reset unit 60. The support unit provides support for the energy storage unit 10, the impact unit 20, the push unit 30 and the drive unit 40. The drive unit 40 provides power to the push unit 30 and the impact unit 20. The energy storage unit 10 is a medium capable of storing energy through displacement, such as air spring, mechanical spring or rubber element. In this invention, the energy storage unit 10 is an air spring, including a cylinder 11, a piston 12 and a sealing ring 13. The cylinder 11 and the piston 12 form an enclosed space containing gas, sealed by the sealing ring 13 between the cylinder 11 and the piston 12. One end of the impact unit 20 is connected to the piston 12, and the other end of the impact unit 20 is used to drive the fastener into the workpiece, the impact unit 20 moves together with the piston 12. The energy storage unit 10 is used to store the energy, the impact unit 20 drives the fastener into the workpiece along the first direction X under the energy released by the energy storage unit 10.

The impact unit 20 has an initial position, a first transition position, a second transition position and an energy storage position arranged in the direction opposite to the first direction X. The first transition position and the second transition position are located between the initial position and the energy storage position. The push unit 30 has a starting position, a first position corresponding to the first transition position, and a second position corresponding to the second transition position. “The push unit 30 has a first position corresponding to the first transition position” means that when the impact unit 20 is located in the first transition position, the push unit 30 is located in the first position. “The push unit 30 has a second position corresponding to the second transition position” means that when the impact unit 20 is located in the second transition position, the push unit 30 is located in the second position.

The push unit 30 is engaged with the impact unit 20 to drive the impact unit 20 to move. The push unit 30 drives the impact unit 20 from the first transition position to the second transition position. In the initial position, the impact unit 20 is not engaged with the push unit 30; in the first transition position, the impact unit 20 is engaged with the push unit 30; and in the second transition position, the impact unit 20 is disengaged from the push unit 30.

When the impact unit 20 is in the initial position, the drive unit 40 simultaneously drives the impact unit 20 and the push unit 30 to move, that is, the drive unit 40 is engaged with the impact unit 20 and drives the impact unit from the initial position to the first transition position, meanwhile, the drive unit 40 is engaged with the push unit 30 and drives the push unit 30 from the starting position to the first position. Since the moving speed of the impact unit 20 is slower than that of the push unit 30, the push unit 30 catches up with the impact unit 20, the push unit 30 is engaged with the impact unit 20 at the first position, at this time, the impact unit 20 is located at the first transition position. When the push unit 30 is engaged with the impact unit 20, the drive unit 40 is about to be disengaged from the impact unit 20, the push unit 30 is engaged with the impact unit 20 and drives the impact unit 20 from the first transition position to the second transition position. During the process of the push unit 30 driving the impact unit 20 from the first transition position to the second transition position, the drive unit 40 is re-engaged with the impact unit 20. After the impact unit 20 reaches the second transition position, the drive unit 40 is engaged with the impact unit 20 and drives the impact unit 20 from the second transition position to the energy storage position.

The fastener driving machine also includes a reset unit 60 that provides a reset force to move the push unit 30 from the second position to the first position. Under the reset force of the reset unit 60, the push unit 30 moves from the second position to the first position.

The drive unit 40 is engaged with or disengage from the push unit 30. The drive unit 40 includes a motor 43, an output shaft 410, a decelerating mechanism 42 and a drive mechanism 41, the motor 43 provides power to the drive mechanism 41. The drive mechanism 41 includes a drive wheel 411 mounted on the output shaft 410, the drive wheel 411 has a meshing area and a non-meshing area arranged circumferentially, the meshing area is meshed with at least one tooth of the push unit 30 to form a meshing state.

The push unit 30 includes a groove 31, the groove 31 is open in the direction opposite to the first direction X, the impact unit 20 includes a protrusion 21 configured to fit into the groove 31. During a movement of the push unit 30 from the starting position to the first position, the protrusion 21 fits into the groove 31. During a movement of the push unit 30 from the first position to the second position, the protrusion 21 is positioned in the groove 31, the impact unit 20 is pushed by the push unit 30 in the direction opposite to the first direction X. When the impact unit 20 is located at the second transition position, the push unit 30 is located at the second position, the groove 31 is disengaged from the protrusion 21 under the reset force of the reset unit 60.

The impact unit 20 includes a first protrusion 23 and a second protrusion 22, the drive mechanism 41 includes a first engaging structure 44 and a second engaging structure 45. The first engaging structure 44 is positioned in the meshing area of the drive wheel 411. The first engaging structure 44 is engaged with the first protrusion 23 to drive the impact unit 20 from the initial position to the first transition position. The second engaging structure 45 is engaged with the second protrusion 22 to drive the impact unit 20 from the second transition position to the energy storage position. When the impact unit 20 is in the initial position, the first engaging structure 44 is engaged with the first protrusion 23 and drives the impact unit 20 to move, while the drive unit 40 is engaged with the push unit 30 and drives the push unit 30 to move.

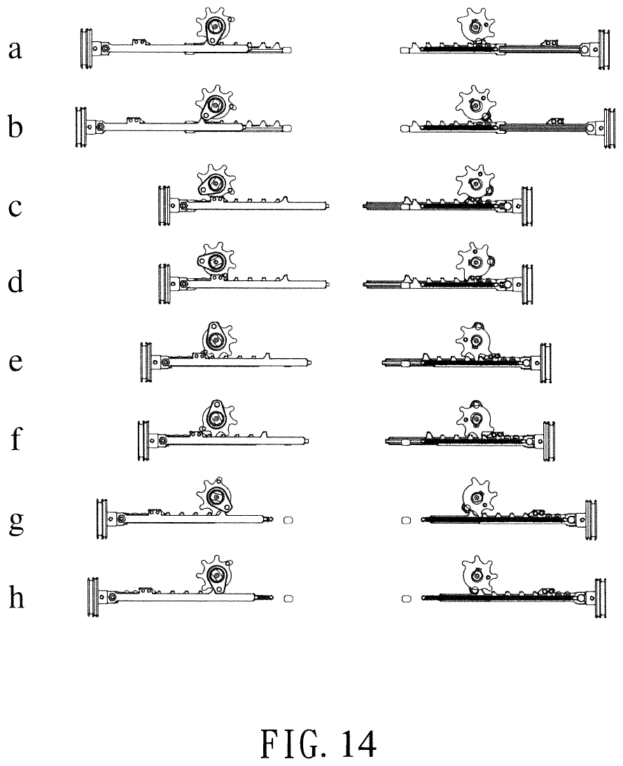

Referencing FIG. 14, states a to h correspond to one operating cycle:

State a represents the initial state of the entire operating cycle, the impact unit 20 is located at the pre-load position, and the piston 12 is near to the top dead center, and the piston 12 has not reached the top dead center. The second protrusion 22 of the impact unit 20 is engaged with the second engaging structure 45 (the pin shaft and the sleeve), at this time, the push unit 30 returns to the starting position and abuts against the first buffer 70. The output shaft 410 rotates counterclockwise, as shown in state b, the output shaft 410 drives the drive wheel 411 and the crank 412 to rotate, the second engaging structure 45 is engaged with the second protrusion 22 and drives the impact unit 20 to move in the direction opposite to the first direction X, and the impact unit 20 drives the piston 12 to move in the direction opposite to the first direction X until the piston 12 reaches the top dead center. The output shaft 410 continues to rotate counterclockwise, as shown in state c, the second protrusion 22 of the impact unit 20 is disengaged from the second engaging structure 45, and the impact unit 20 drives the fastener into the workpiece along the first direction X under the action of the energy released by the energy storage unit 10. After the action of fastener driving, the piston 12 abuts against the second buffer 80, the piston 12 stays at the bottom dead center, the impact unit 20 is located at the initial position. The output shaft 410 drives the drive wheel 411 and the crank 412 to rotate counterclockwise, as shown in state d, the first engaging tooth 413 of the meshing area of the drive wheel 411 begins to be engaged with the second engaging tooth 33 of the push unit 30 to drive the push unit 30 to move in the direction opposite to the first direction X, that is, the drive wheel 411 drives the push unit 30 from the starting position to the first position. Meanwhile, the first engaging structure 44 begins to be engaged with the first protrusion 23 to drive the impact unit 20 to move in the direction opposite to the first direction X, that is, the first engaging structure 44 is engaged with the first protrusion 23 to drive the impact unit 20 from the initial position to the first transition position.

The output shaft 410 continues to rotate counterclockwise, as shown in state e, since the moving speed of the impact unit 20 is less than the moving speed of the push unit 30, the push unit 30 catches up with the impact unit 20 in the direction opposite to the first direction X, the push unit 30 is engaged with the impact unit 20 at the first position, that is, the protrusion 21 of the impact unit 20 fits into the groove 31 of the push unit 30 at the first position. When the push unit 30 is located at the first position, the impact unit 20 is located at the first transition position. At this time, the first engaging structure 44 is about to be disengaged from the first protrusion 23. The output shaft 410 continues to rotate counterclockwise, as shown in state f, the output shaft 410 drives the drive wheel 411 and the crank 412 to rotate, the drive wheel 411 drives the push unit 30 to move, the push unit 30 drives the impact unit 20 from the first transition position to the second transition position. The impact unit 20 drives the piston 12 to move in the direction opposite to the first direction X to compress the air spring, the first engaging structure 44 has been disengaged from the first protrusion 23. The output shaft 410 continues to rotate counterclockwise, shown in state g, the second engaging structure 45 (the pin shaft and the sleeve) begins to be engaged with the second protrusion 22 of the impact unit 20, while the first engaging tooth 413 of the drive wheel 411 is about to be disengaged from the second engaging tooth 33 of the push unit 30. The output shaft 410 continues to rotate counterclockwise, shown in state h, the first engaging tooth 413 of the drive wheel 411 is disengaged from the second engaging tooth 33 of the push unit 30, at this time, the push unit 30 is located at the second position, the push unit 30 is about to move from the second position to the first position under the reset force of the reset unit 60 until the push unit 30 returns to the starting position and abuts against the first buffer 70. Meanwhile, the impact unit 20 is located at the second transition position, the second engaging structure 45 is engaged with the second protrusion 22 to drive the impact unit 20 from the second transition position to the energy storage position, the impact unit 20 drives the piston 12 to move to compress the air spring. The output shaft 410 continues to rotate counterclockwise, the second engaging structure 45 is engaged with the second protrusion 22 to drive the impact unit 20 to the pre-load position, completing one operating cycle, as shown in state a.

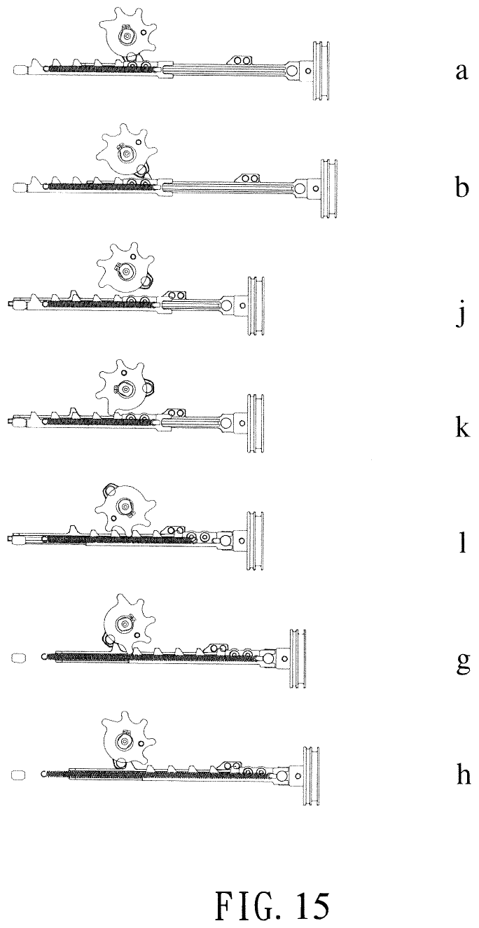

In reference to FIG. 15, from some reasons, the fastener may get stuck in the fastener guide plate 52, in this time, the impact unit 20 could stop at any position along the first direction X, as shown in state j. Since the push unit 30 and the impact unit 20 are not fixedly connected, the push unit 30 can return to the starting position and abut against the first buffer 70 under the reset force of the reset unit 60. The first engaging tooth 413 of the meshing area of the drive wheel 411 is properly engaged with the second engaging tooth 33 of the push unit 30. The output shaft 410 continues to rotate counterclockwise, as shown in state k, because of the position where the impact unit 20 stops at, the first engaging structure 44 cannot be engaged with the first protrusion 23 of the impact unit 20. The first engaging tooth 413 of the meshing area of the drive wheel 411 is about to be engaged with the second engaging tooth 33 of the push unit 30, the drive wheel 411 drives the push unit 30 to move in the direction opposite to the first direction X. The output shaft 410 continues to rotate counterclockwise, as shown in state l, the first engaging tooth 413 of the meshing area of the drive wheel 411 is engaged with the second engaging tooth 33 of the push unit 30. The drive wheel 411 drives the push unit 30 from the starting position in the direction opposite to the first direction X until the push unit 30 is re-engaged with the impact unit 20. The push unit 30 drives the impact unit 20 to move, and the impact unit 20 drives the piston 12 to move in the direction opposite to the first direction X to compress the air spring. The output shaft 410 continues to rotate counterclockwise, as shown in state g, the second engaging structure 45 (the pin shaft and the sleeve) begins to be engaged with the second protrusion 22 of the impact unit 20, while the first engaging tooth 413 of the drive wheel 411 is about to be disengaged from the second engaging tooth 33 of the push unit 30. The output shaft 410 continues to rotate counterclockwise, as shown in state h, the first engaging tooth 413 of the meshing area of the drive wheel 411 is disengaged from the second engaging tooth 33 of the push unit 30, at this time, the push unit 30 is in the second position, and under the reset force of the reset unit 60, the push unit 30 moves from the second position to the first position until the push unit 30 returns to the starting position and abuts against the first buffer 70. Meanwhile, the impact unit 20 is in the second transition position, and the second engaging structure 45 is engaged with the second protrusion 22 to drive the impact unit 20 from the second transition position to the energy storage position, the impact unit 20 drives the piston 12 to move in the direction opposite to the first direction X to compress the air spring. The output shaft 410 continues to rotate counterclockwise, the second engaging structure 45 is engaged with the second protrusion 22 to drive the impact unit 20 to the pre-load position, as shown in state a, completing the operating cycle.

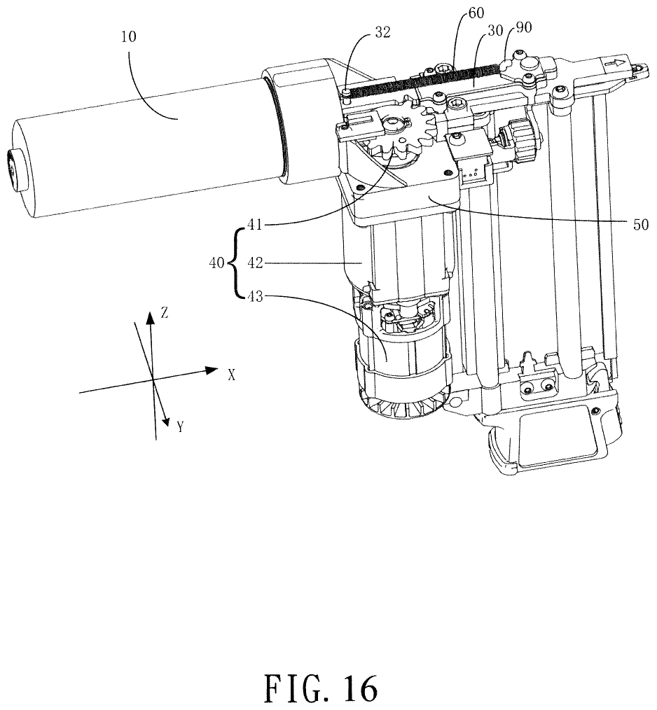

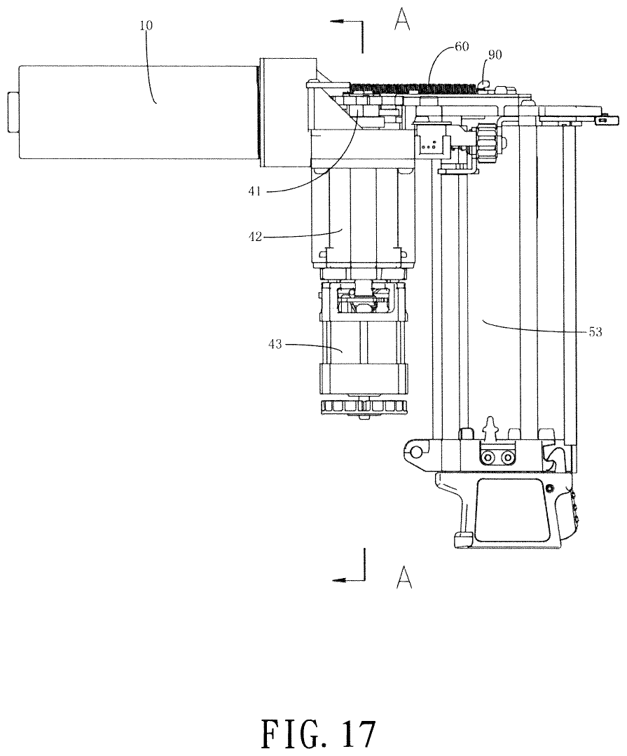

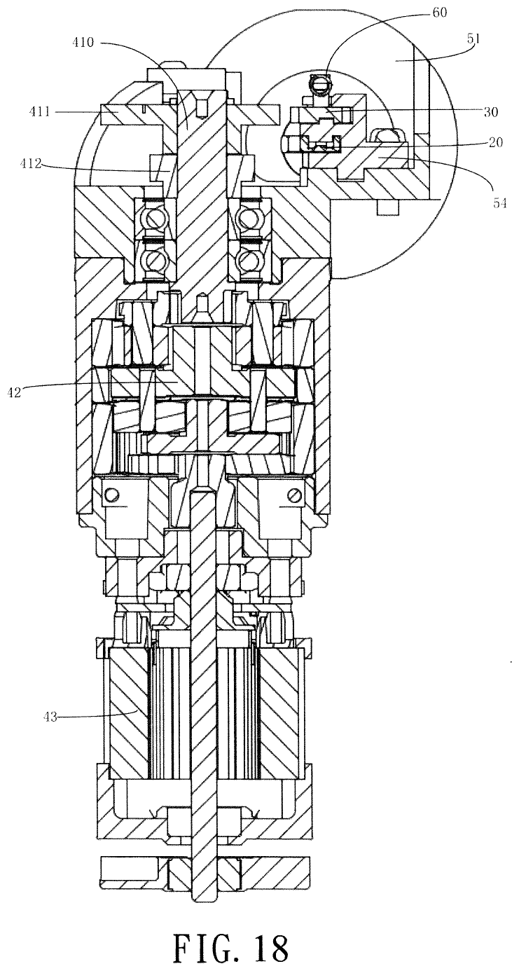

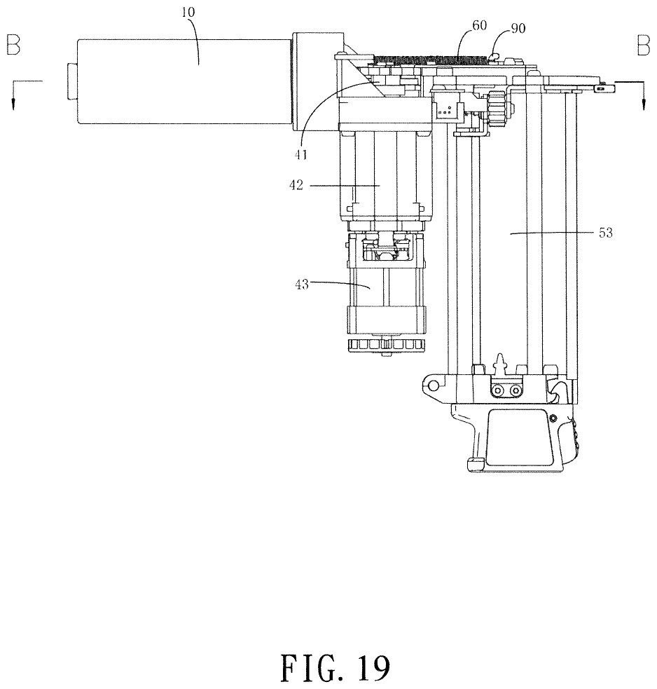

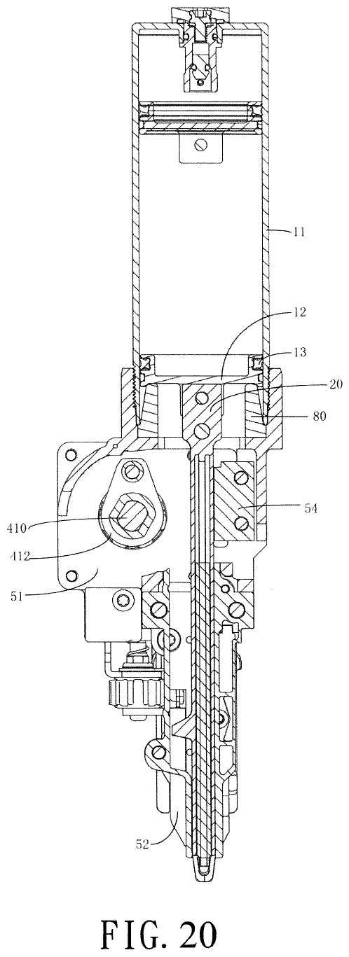

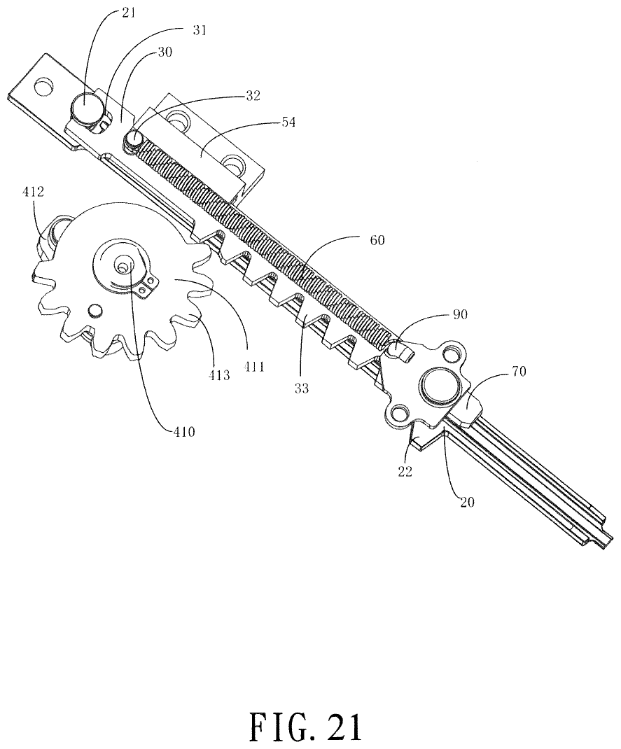

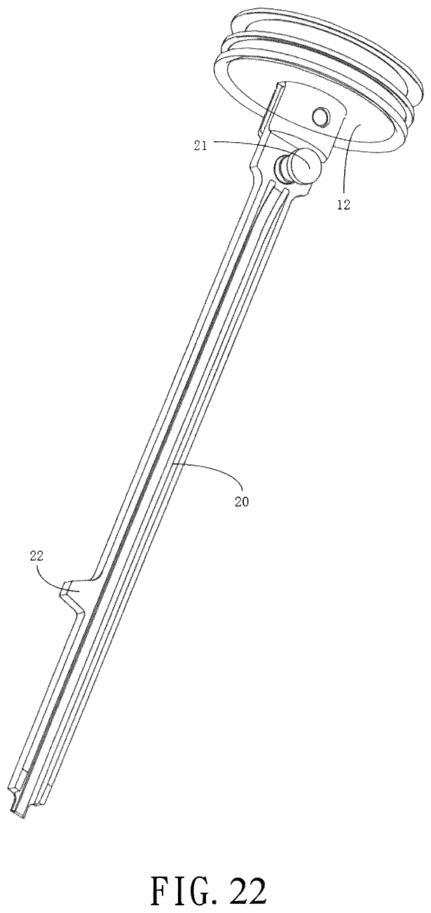

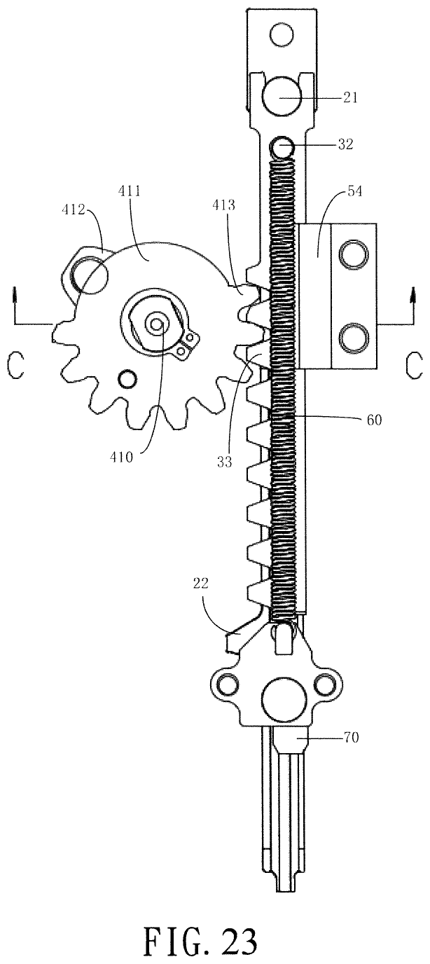

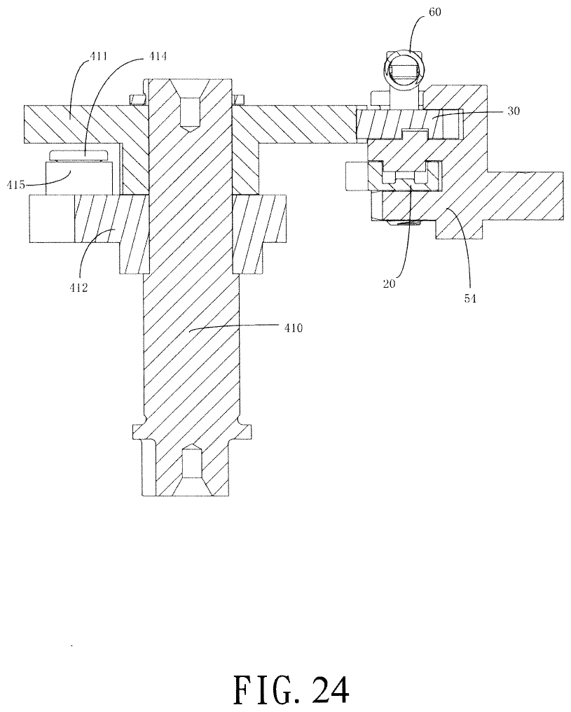

Referencing FIGS. 16 to 26, the third embodiment of the present invention provides a fastener driving machine, the fastener driving machine includes an energy storage unit 10, an impact unit 20, a push unit 30, a drive unit 40, a support unit 50 and a reset unit 60. The support unit 50 provides support for the energy storage unit 10, the impact unit 20, the push unit 30 and the drive unit 40. The reset unit 60 has a first end and a second end opposite to each other, the first end of the reset unit 60 is connected with the support unit 50 and the second end of the reset unit 60 is connected with the push unit 30. The support unit 50 includes a first hook 90, the first end of the reset unit 60 is mounted on the first hook 90 of the support unit 50. The push unit 30 includes a second hook 32, the second end of the reset unit 60 is mounted on the second hook 32 of the push unit 30. The energy storage unit 10 is used to store energy. The impact unit 20 drives the fastener into the workpiece along the first direction X under the action of the energy released by the energy storage unit 10. The impact unit 20 has an initial position, a transition position and an energy storage position arranged in the direction opposite to the first direction X. The push unit 30 is engaged with the impact unit 20 and drives the impact unit 20 from the initial position to the transition position, the push unit 30 has a first position corresponding to the initial position and a second position corresponding to the transition position. The drive unit 40 is engaged with or disengaged from the push unit 30. The reset unit 60 provides a reset force to move the push unit 30 from the second position to the first position. When the impact unit 20 is located at the transition position, the push unit 30 is located at the second position, the push unit 30 is disengaged from the impact unit 20 at the second position under the reset force of the reset unit 60. The reset unit 60 extends in the moving direction of the impact unit 20. When the push unit 30 is in the second position, the reset unit 60 is in a stretched state.

The push unit 30 includes a groove 31, the groove 31 is open in the direction opposite to the first direction X. The impact unit 20 includes a protrusion 21 configured to fit into the groove 31. During a movement of the push unit 30 from the first position to the second position, the protrusion 21 is positioned in the groove 31, the impact unit 20 is pushed by the push unit 30 in the direction opposite to the first direction X. When the impact unit 20 is located at the transition position, the push unit 30 is located at the second position, the groove 31 is disengaged from the protrusion 21 at the second position under the reset force of the reset unit 60.

The drive unit 40 includes a motor 43, an output shaft 410, a decelerating mechanism 42 and a drive mechanism 41, the motor 43 provides power to the drive mechanism 41. The drive mechanism 41 includes a drive wheel 411 and a crank 412, which are mounted on the output shaft 410. The drive wheel 411 and the crank 412 are positioned on different planes along the axial direction of the output shaft 410. The crank 412 can be engaged with or disengaged from the impact unit 20. The drive wheel 411 has a meshing area and a non-meshing area arranged circumferentially. The meshing area is meshed with at least one tooth of the push unit 30 to form a meshing state. After the meshing area is disengaged from the push unit 30, the crank 412 is engaged with the impact unit 20, the crank 412 drives the impact unit 20 from the transition position to the energy storage position. When the impact unit 20 is disengaged from the crank 412, the impact unit 20 drives the fastener into the workpiece under the action of the energy released by the energy storage unit 10.

The push unit 30 and the drive wheel 411 are arranged oppositely along the second direction Y, the second direction Y is perpendicular to the first direction X. The push unit 30 includes a tooth-meshing region configured to be meshed with the drive wheel 411. The reset unit 60 is located on the side of the tooth-meshing region facing away from the drive wheel 411 along the second direction Y. The reset unit 60 and the impact unit 20 are arranged along a third direction Z, the third direction Z are perpendicular to the first direction X and the second direction Y.

The fastener driving machine also includes a first buffer 70. The push unit 30 returns to the first position and abuts against the first buffer 70 under the reset force of the reset unit 60. Specifically, the first buffer 70 is mounted on the fastener guide plate of the support unit 50. When the push unit 30 is returning to the first position under the reset force of the reset unit 60, the push unit 30 abuts against the first buffer 70. This first buffer 70 absorbs the residual energy when the push unit 30 returns to the first position. Additionally, the first buffer 70 restricts a movement of the push unit 30 along the first direction X.

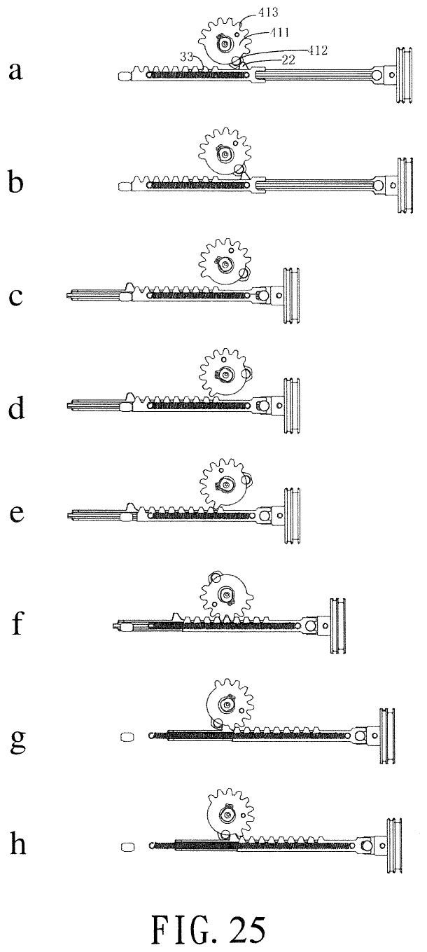

Referencing FIG. 25, states a to h correspond to a normal operating cycle.

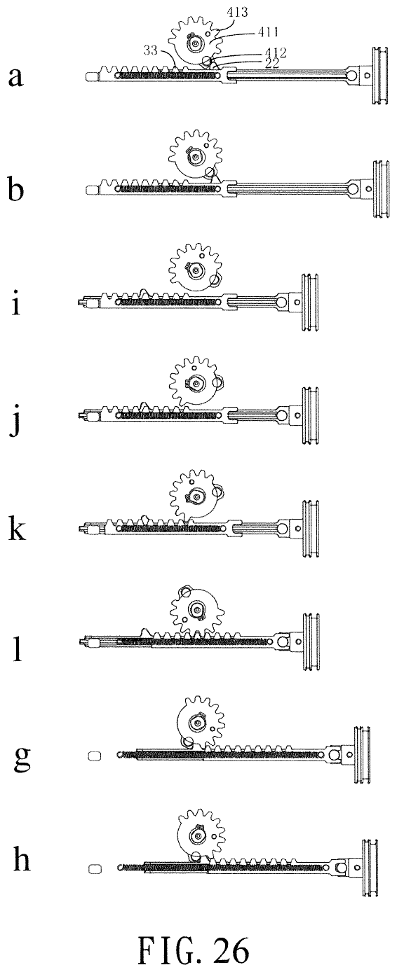

Referencing FIG. 26, states a, b, i, j, k, l, g, and h represent an operating cycle under a condition that for some reasons, the fastener is stuck in the fastener guide plate, the impact unit 20 may stop at any position along the first direction X, as shown in state i.

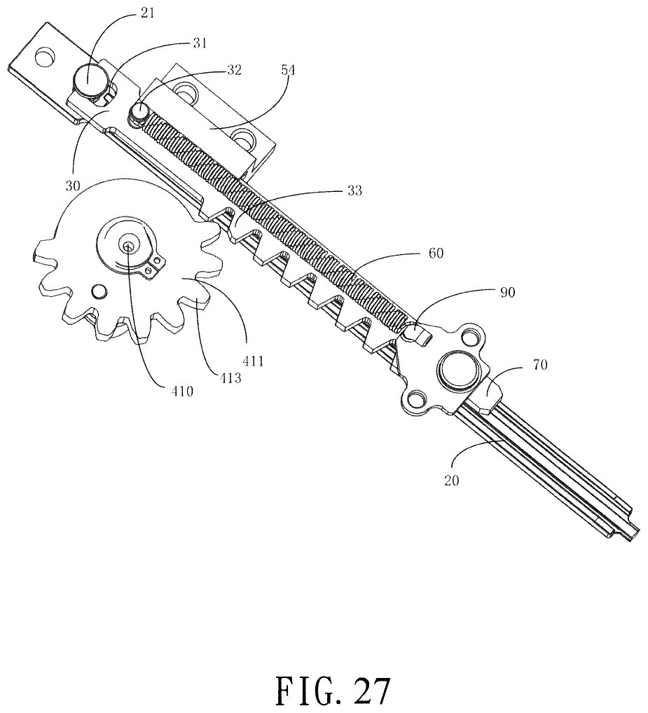

Referencing FIGS. 27 to 29, the fourth embodiment of the present invention also provides a fastener driving machine, FIG. 27 only provides a structural schematic diagram of a structure different from the structure of the third embodiment, please refer to FIGS. 16 to 24 for the same structure as the third embodiment, the fastener driving machine includes an energy storage unit 10, an impact unit 20, a push unit 30, a drive unit 40, a support unit 50 and a reset unit 60. The support unit 50 provides support for the energy storage unit 10, the impact unit 20, the push unit 30 and the drive unit 40. The energy storage unit 10 is used to store energy. The impact unit 20 drives the fastener into the workpiece along the first direction X under the action of the energy released by the energy storage unit 10. The impact unit 20 has an energy storage position and an initial position. The push unit 30 drives the impact unit 20 from the initial position to the energy storage position, the push unit 30 has a first position corresponding to the initial position and a second position corresponding to the energy storage position. The drive unit 40 can be engaged with or disengaged from the push unit 30. The reset unit 60 provides a reset force to move the push unit 30 from the second position to the first position. Under the action of the energy storage unit 10 and the reset unit 60, the push unit 30 moves from the second position to the first position. During a movement of the pushing unit 30 from the second position to the first position, the push unit 30 is disengaged from the impact unit 20.

The drive unit 40 includes a motor 43, an output shaft 410, a decelerating mechanism 42 and a drive mechanism 41, the motor 43 provides power to the drive mechanism 41. The drive mechanism 41 includes a drive wheel 411 mounted on the output shaft 410. The drive wheel 411 has a meshing area and a non-meshing area arranged circumferentially, the meshing area is meshed with at least one tooth of the push unit 30 to form a meshing state.

In this embodiment, the drive mechanism 41 only includes a drive wheel 411 and does not include a crank. The impact unit 20 does not have a protrusion, and there is no engaging relationship between the impact unit 20 and the drive mechanism 41. When the output shaft 410 drives the drive wheel 411 to rotate, the drive wheel 411 drives the push unit 30 from the starting position to the first position. In the first position, the push unit 30 can be engaged with the impact unit 20 to drive the impact unit 20 from the initial position to the energy storage position, the impact unit 20 drives the piston 12 to move in the direction opposite to the first direction X. After the impact unit 20 is driven to the energy storage position (that is, the piston 12 is driven to the top dead center), the drive wheel 411 is disengaged from the push unit 30, under the action of the energy released by the energy storage unit 10, the impact unit 20 moves along the first direction X, that is, the impact unit 20 moves from the energy storage position to the initial position. Simultaneously, under the action of the energy released by the energy storage unit 10 and the reset force provided by the reset unit 60, the push unit 30 moves along the first direction X, that is, the push unit 30 moves from the second position to the first position until the push unit 30 returns to the starting position. Since the push unit 30 is not fixedly connected to the impact unit 20, during a movement of the push unit 30 from the second position to the first position until the push unit 30 returns to the starting position, the push unit 30 is disengaged from the impact unit 20. Preferably, during a movement of the push unit 30 from the second position to the first position, the push unit 30 is disengaged from the impact unit 20.

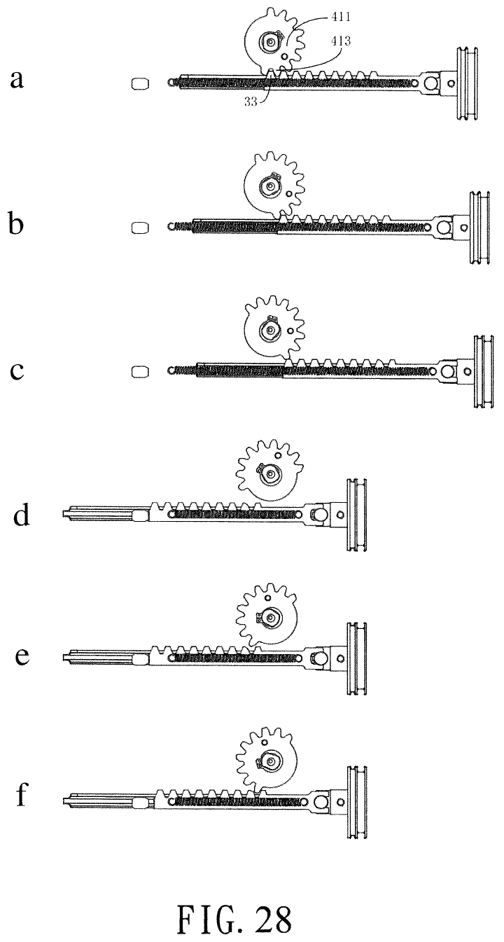

Referencing FIG. 28, states a to f represent a normal operating cycle.

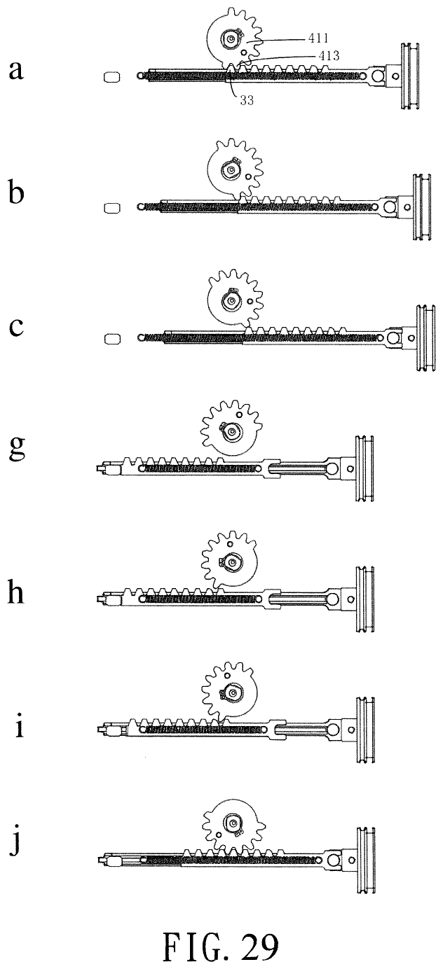

Referencing FIG. 29, states a, b, c, g, h, i, and j represent an operating cycle under a condition that for some reasons, the fastener is stuck in the fastener guide plate, the impact unit 20 may stop at any position along the first direction X, as shown in state g.

In this invention, the push unit 30 can independently return to the starting position under the reset force of the reset unit 60. When the impact unit 20 is stopping at an abnormal position due to a jam, the drive unit 40 can be still engaged with the push unit 30 correctly, the drive unit 40 drives the push unit 30 to the abnormal position where the impact unit 20 stops at, the push unit 30 can be re-engaged with the impact unit 20 properly.

The above description is merely a preferred embodiment of the present invention and does not limit the invention in any form. Although the invention has been disclosed as above with a preferred embodiment, it is not intended to limit the invention. Any technical personnel familiar with this field may make slight modifications or equivalent implementations without departing from the scope of the technical solution of the present invention. Any simple modifications, equivalent changes, and adaptations based on the technical essence of the present invention still fall within the scope of the technical solution of the present invention.

I claim:

1. A fastener driving machine, comprising:
an energy storage unit, configured to store energy;
an impact unit, configured to drive a fastener into a workpiece in a first direction under an action of the energy released by the energy storage unit, the impact unit having an initial position, a first transition position, a second transition position and an energy storage position arranged in a direction opposite to the first direction;
a push unit, configured to drive the impact unit to move, the push unit having a first position corresponding to the first transition position and a second position corresponding to the second transition position;
a drive unit, configured to provide power to the push unit and the impact unit;
a reset unit, configured to provide a reset force to move the push unit from the second position to the first position; wherein in the initial position, the impact unit is not engaged with the push unit;
in the first transition position, the impact unit is engaged with the push unit; in the second transition position, the impact unit is disengaged from the push unit; and wherein
when the impact unit is in the initial position, the drive unit is engaged with the impact unit and drives the impact unit to move, after the impact unit moves a predetermined distance, the drive unit is engaged with the push unit and drives the push unit to move, so that the push unit is engaged with the impact unit at the first position and drives the impact unit from the first transition position to the second transition position.

2. The fastener driving machine according to claim 1, wherein after the impact unit reaches the second transition position, the drive unit drives the impact unit from the second transition position to the energy storage position.

3. The fastener driving machine according to claim 1, further comprising a support unit configured to support the energy storage unit, the impact unit, the push unit and the drive unit; wherein the reset unit has a first end and a second end opposite to each other, the first end being connected with the support unit and the second end being connected with the push unit.

4. The fastener driving machine according to claim 1, wherein the drive unit comprises a motor and a drive mechanism, the motor being configured to provide power to the drive mechanism, the drive mechanism comprising a drive wheel, the drive wheel having a meshing area and a non-meshing area arranged circumferentially; wherein the meshing area is configured to be meshed with at least one tooth of the push unit to form a meshing state.

5. The fastener driving machine according to claim 4, wherein the impact unit comprises a first protrusion and a second protrusion, and the drive mechanism comprises a first engaging structure and a second engaging structure, the first engaging structure being configured to be engaged with the first protrusion to drive the impact unit from the initial position to the first transition position, the second engaging structure being configured to be engaged with the second protrusion to drive the impact unit from the second transition position to the energy storage position.

6. The fastener driving machine according to claim 5, wherein the second engaging structure is configured to be engaged with or disengaged from the second protrusion; and when the second engaging structure is disengaged from the second protrusion, the impact unit drives the fastener into the workpiece under the action of the energy released by the energy storage unit.

7. The fastener driving machine according to claim 1, wherein the drive unit comprises a drive mechanism, the drive mechanism comprising a drive wheel, the push unit and the drive wheel being disposed opposite to each other in a second direction, the push unit having a tooth-meshing region configured to be meshed with the drive wheel; the reset unit being located on a side of the tooth-meshing region facing away from the drive wheel in the second direction, the second direction being perpendicular to the first direction.

8. The fastener driving machine according to claim 7, wherein the impact unit and the reset unit are arranged along a third direction, the third direction being perpendicular to the first direction and the second direction.

9. The fastener driving machine according to claim 1, wherein the push unit comprises a groove that opens in a direction opposite to the first direction, and the impact unit comprises a protrusion configured to fit into the groove; and during a movement of the push unit from the first position to the second position, the protrusion is positioned in the groove, the impact unit is pushed by the push unit in the direction opposite to the first direction.

10. The fastener driving machine according to claim 1, further comprising a buffer, wherein the push unit moves from the second position to the first position under the reset force of the reset unit until the push unit abuts against the buffer.

11. A fastener driving machine, comprising:
an energy storage unit, configured to store energy;
an impact unit, configured to drive a fastener into a workpiece in a first direction under an action of the energy released by the energy storage unit, the impact unit having an initial position, a first transition position, a second transition position and an energy storage position arranged in a direction opposite to the first direction;
a push unit, configured to drive the impact unit to move, the push unit having a first position corresponding to the first transition position and a second position corresponding to the second transition position;
a drive unit, configured to provide power to the push unit and the impact unit;
a reset unit, configured to provide a reset force to move the push unit from the second position to the first position; wherein in the initial position, the impact unit is not engaged with the push unit;
in the first transition position, the impact unit is engaged with the push unit; in the second transition position, the impact unit is disengaged from the push unit; and wherein
when the impact unit is in the initial position, the drive unit simultaneously drives the impact unit and the push unit to move; at the first position, the push unit is engaged with the impact unit and drives the impact unit from the first transition position to the second transition position.

12. The fastener driving machine according to claim 11, wherein after the impact unit reaches the second transition position, the drive unit drives the impact unit from the second transition position to the energy storage position.

13. The fastener driving machine according to claim 11, wherein the push unit comprises a groove that opens in a direction opposite to the first direction, and the impact unit comprises a protrusion configured to fit into the groove; and during a movement of the push unit from the first position to the second position, the protrusion is positioned in the groove, the impact unit is pushed by the push unit in the direction opposite to the first direction.

14. The fastener driving machine according to claim 11, wherein the drive unit comprises a motor and a drive mechanism, the motor being configured to provide power to the drive mechanism, the drive mechanism comprising a drive wheel, the drive wheel comprising a meshing area and a non-meshing area arranged circumferentially, wherein the meshing area is configured to be meshed with at least one tooth of the push unit to form a meshing state.

15. The fastener driving machine according to claim 14, wherein the impact unit comprises a first protrusion and a second protrusion, and the drive mechanism comprises a first engaging structure and a second engaging structure, the first engaging structure being configured to be engaged with the first protrusion to drive the impact unit from the initial position to the first transition position; the second engaging structure being configured to be engaged with the second protrusion to drive the impact unit from the second transition position to the energy storage position.

16. A fastener driving machine, comprising:
an energy storage unit, configured to store energy;
an impact unit, configured to drive a fastener into a workpiece in a first direction under an action of the energy released by the energy storage unit, the impact unit having an initial position, a transition position and an energy storage position arranged in a direction opposite to the first direction;
a push unit, configured to be engaged with the impact unit to drive the impact unit from the initial position to the transition position, the push unit having a first position corresponding to the initial position and a second position corresponding to the transition position;
a drive unit, configured to be engaged with or disengaged from the push unit;
a reset unit, configured to provide a reset force to move the push unit from the second position to the first position; wherein
when the impact unit is in the transition position, the push unit is in the second position, the push unit is disengaged from the impact unit under the reset force of the reset unit.

17. The fastener driving machine according to claim 16, wherein the push unit comprises a groove that opens in a direction opposite to the first direction, and the impact unit comprises a protrusion configured to fit into the groove; and during a movement of the push unit from the first position to the second position, the protrusion is positioned in the groove, the impact unit is pushed by the push unit in the direction opposite to the first direction; and when the impact unit is in the transition position, the push unit is in the second position, the groove is disengaged from the protrusion under the reset force of the reset unit.

18. The fastener driving machine according to claim 16, wherein the drive unit comprises a motor and a drive mechanism, the motor being configured to provide power to the drive mechanism, the drive mechanism comprising a drive wheel with a meshing area and a non-meshing area arranged circumferentially, wherein the meshing area is configured to be meshed with at least one tooth of the push unit to form a meshing state.

19. The fastener driving machine according to claim 18, wherein the drive mechanism further comprises a crank configured to be engaged with or disengaged from the impact unit, and when the crank is disengaged from the impact unit, the impact unit drives the fastener into the workpiece under the action of the energy released by the energy storage unit.

20. The fastener driving machine according to claim 16, wherein the drive unit comprises a drive mechanism, the drive mechanism comprising a drive wheel, the push unit and the drive wheel being disposed opposite to each other in a second direction; the push unit having a tooth-meshing region configured to be meshed with the drive wheel; the reset unit being located on a side of the tooth-meshing region facing away from the drive wheel in the second direction, the second direction being perpendicular to the first direction; the impact unit and the reset unit being arranged along a third direction, the third direction being perpendicular to the first direction and the second direction.
